(19) United States
(12) Patent Application Publication
(10) Pub. No.: US 2013/0236215 A1
(43) Pub. Date: Sep. 12, 2013

(54) DEVELOPING DEVICE AND IMAGE FORMING APPARATUS

(71) Applicant: FUJI XEROX CO., LTD., Tokyo (JP)

(72) Inventors: Takashi OCHI, Kanagawa (JP); Yasuaki WATANABE, Kanagawa (JP); Shigeru INABA, Kanagawa (JP); Nobumasa FURUYA, Kanagawa (JP); Masanori KATO, Kanagawa (JP); Shinichiro FUJIMORI, Kanagawa (JP); Satoru YUGETA, Kanagawa (JP); Keisuke UCHIYAMA, Kanagawa (JP); Shota OBA, Kanagawa (JP)

(73) Assignee: FUJI XEROX CO., LTD., Tokyo (JP)

(21) Appl. No.: 13/683,465

(22) Filed: Nov. 21, 2012

(30) Foreign Application Priority Data
Mar. 6, 2012 (JP) 2012-049306

(51) Int. Cl. G03G 15/09

(52) U.S. Cl. CPC G03G 15/0121
USPC 399/269

(57) ABSTRACT

A developing device includes a housing accommodating a developer containing a toner and a magnetic carrier; first and second developing members facing an image bearing member and having substantially-cylindrical first and second rotatable sleeves and first and second magnet rollers supported therein and having magnetic poles; a supply member supplying the developer onto the first sleeve; a layer regulating member facing the first sleeve and regulating a layer of the developer; and an electrode member facing the second sleeve with a distance therebetween and disposed upstream, in the second-sleeve rotational direction, of where the second sleeve receives the developer from the first sleeve and downstream of where the second developing member faces the image bearing member. An electric field removing the toner from the second sleeve or causing the toner on the carrier to adhere onto the second sleeve is generated between the electrode member and the second sleeve.

### CROSS-REFERENCE TO RELATED APPLICATIONS

This application is based on and claims priority under 35 USC 119 from Japanese Patent Application No. 2012-049306 filed Mar. 6, 2012.

### BACKGROUND

### Technical Field

The present invention relates to developing devices and image forming apparatuses.

### SUMMARY

According to an aspect of the invention, there is provided a developing device including an accommodation housing, multiple developing members, a supply member, a layer regulating member, and an electrode member. The accommodation housing accommodates a two-component developer containing a toner and a magnetic carrier. The multiple developing members are disposed facing an image bearing member having a latent image formed thereon due to a difference in electrostatic potential and include a first developing member and a second developing member. The first developing member has a substantially-cylindrical first sleeve rotationally driven in a circumferential direction thereof and a first magnet roller fixedly supported within the first sleeve and provided with magnetic poles at multiple positions in the circumferential direction. The second developing member has a substantially-cylindrical second sleeve rotationally driven in a circumferential direction thereof and a second magnet roller fixedly supported within the second sleeve and provided with magnetic poles at multiple positions in the circumferential direction. The supply member supplies the two-component developer onto the first sleeve of the first developing member. The layer regulating member faces the first sleeve and regulates a layer of the two-component developer supported on a peripheral surface of the first sleeve by the first magnet roller provided within the first sleeve. The electrode member faces the second sleeve with a certain distance therebetween and is disposed upstream, in a rotational direction of the second sleeve included in the second developing member, of a position where the second sleeve receives the two-component developer from the first sleeve and downstream of a position where the second developing member having received the two-component developer regulated by the layer regulating member faces the image bearing member. An electric field that causes the toner adhered to a peripheral surface of the second sleeve to be removed therefrom or an electric field that causes the toner adhered to a surface of the magnetic carrier to adhere to the peripheral surface of the second sleeve is generated between the electrode member and the second sleeve.

### BRIEF DESCRIPTION OF THE DRAWINGS

Exemplary embodiments of the present invention will be described in detail based on the following figures, wherein:

FIG. 1 schematically illustrates the configuration of an image forming apparatus according to an exemplary embodiment of the present invention;

FIG. 2 schematically illustrates the configuration of a developing device included in the image forming apparatus shown in FIG. 1, according to a first exemplary embodiment of the present invention;

FIG. 3 schematically illustrates how toner particles, magnetic carrier particles, and external additive particles behave at a position where a developing roller and a photoconductor drum face each other;

FIGS. 4A and 4B schematically illustrate other modes for applying voltage to an electrode member and a developing roller;

FIG. 5 schematically illustrates a state where a cleaning device is provided for the electrode member included in the developing device shown in FIG. 2;

FIG. 6 schematically illustrates an example in which the developing device is equipped with two electrode members;

FIG. 7 schematically illustrates a developing device according to a second exemplary embodiment of the present invention; and

FIG. 8 schematically illustrates a developing device according to a third exemplary embodiment of the present invention.

### DETAILED DESCRIPTION

Exemplary embodiments of the present invention will be described below with reference to the drawings.

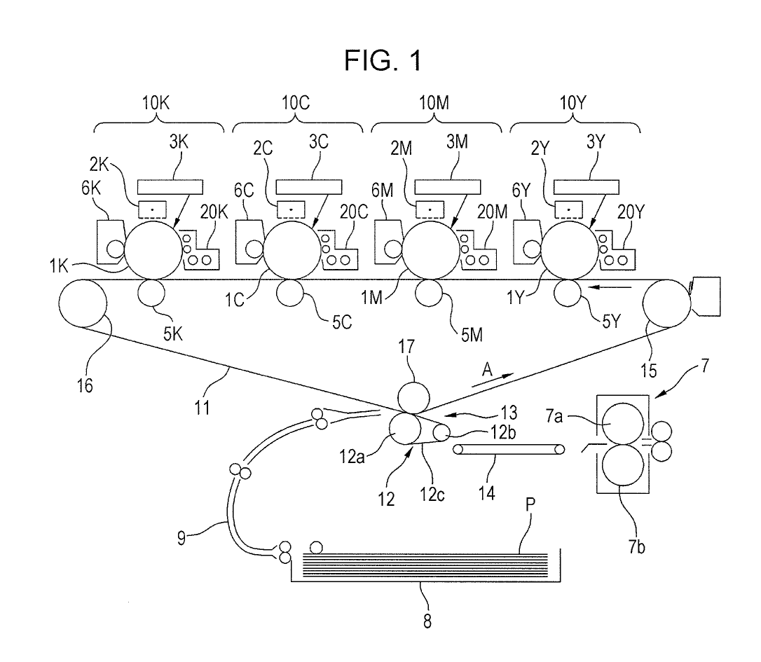

FIG. 1 schematically illustrates the configuration of an image forming apparatus according to an exemplary embodiment of the present invention.

The image forming apparatus forms a color image by using toners of four colors and includes electrophotographic image forming units 10Y, 10M, 10C, and 10K that respectively output yellow (Y), magenta (M), cyan (C), and black (K) images, and an intermediate transfer belt 11 that faces these units.

The intermediate transfer belt 11 is wrapped around a drive roller 15 that is rotationally driven, an adjustment roller 16 that adjusts deviation of the intermediate transfer belt 11 in the width direction thereof, and an opposing roller 17. The intermediate transfer belt 11 is disposed facing the image forming units 10Y, 10M, 10C, and 10K and is rotationally driven in a direction indicated by an arrow A in FIG. 1.

The image forming unit 10Y that forms a yellow toner image, the image forming unit 10M that forms a magenta toner image, the image forming unit 10C that forms a cyan toner image, and the image forming unit 10K that forms a black toner image are arranged in that order from the upstream side in the rotational direction of the intermediate transfer belt 11, and a second-transfer member 12 for performing a second-transfer process is disposed in contact with the intermediate transfer belt 11 at the downstream side of the image forming unit 10K.

A recording medium in the form of a sheet is transported from a recording-medium accommodation section 8 to a second-transfer position 13, at which the second-transfer member 12 faces the intermediate transfer belt 11, via a transport path 9. A transport device 14 that transports the recording medium having toner images transferred thereon and a fixing device 7 that fixes the toner images onto the recording medium by heating and pressing the toner images are provided downstream of the second-transfer position 13 in the transport path 9 for the recording medium.

An output-sheet supporter (not shown) that supports a stack of recording media having toner images fixed thereon is disposed further downstream.

Each of the image forming units 10 has a photoconductor drum 1 that functions as an image bearing member by having an electrostatic latent image formed on a surface thereof. The photoconductor drum 1 is surrounded by a charging device 2 that electrostatically charges the surface of the photoconductor drum 1, a developing device 20 that forms a toner image by selectively transferring toner to the latent image formed on the photoconductor drum 1, a first-transfer roller 5 that first-transfers the toner image on the photoconductor drum 1 onto the intermediate transfer belt 11, and a cleaning device 6 that removes residual toner from the photoconductor drum 1 after the transfer process. Furthermore, for each of the photoconductor drums 1, an exposure device 3 that generates image light based on an image signal is provided. The exposure device 3 radiates the image light onto the corresponding photoconductor drum 1 so as to write an electrostatic latent image on the electrostatically-charged photoconductor drum 1. In this exemplary embodiment, the photoconductor drum 1 is electrostatically charged to −800 V by the charging device 2. With regard to the electric potential on the surface of the photoconductor drum 1 when the electrostatic latent image is formed thereon, an image area where the electric potential is attenuated due to the exposure process is −400 V, whereas a non-image area is maintained at −800 V.

The second-transfer member 12 facing the opposing roller 17 with the intermediate transfer belt 11 interposed therebetween has a second-transfer roller 12a, an auxiliary roller 12b, and a second-transfer belt 12c wrapped around these rollers. The second-transfer belt 12c is nipped between the opposing roller 17 and the second-transfer roller 12a in a state where the second-transfer belt 12c overlaps the intermediate transfer belt 11, and is rotated as the intermediate transfer belt 11 is rotationally driven. When a recording medium is delivered between the intermediate transfer belt 11 and the second-transfer belt 12c, the two belts transport the recording medium by nipping the recording medium therebetween. In order to generate a transfer electric field between the second-transfer roller 12a and the opposing roller 17, a transfer voltage is applied to the opposing roller 17.

The fixing device 7 includes a heating roller 7a having a built-in heating source and a pressure roller 7b that is in pressure contact with the heating roller 7a, and forms a nip at a position where these rollers are in contact with each other. The recording medium having the toner images transferred thereon is delivered to the nip, where the recording medium is heated and pressed between the rotationally-driven heating roller 7a and pressure roller 7b, whereby the toner images are fixed onto the recording medium.

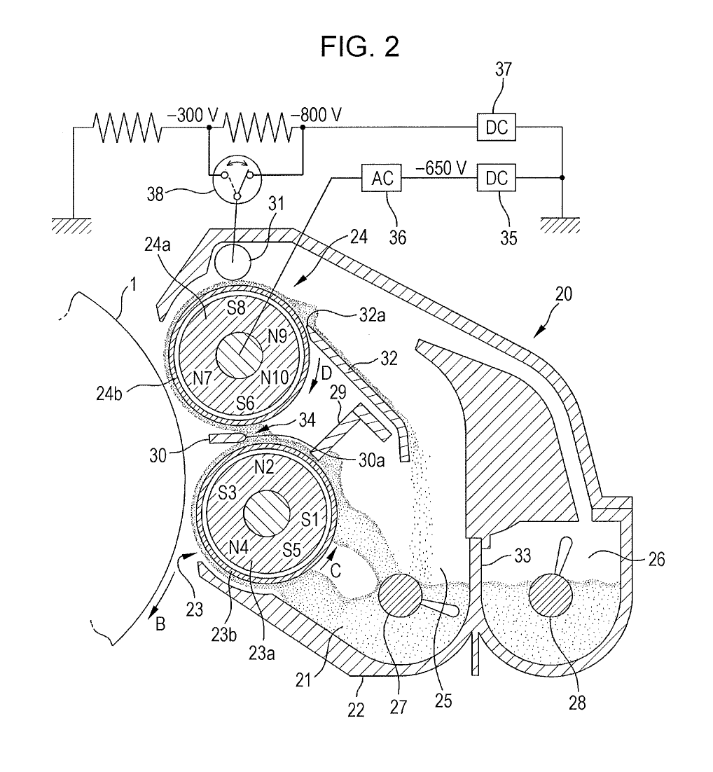

Referring to FIG. 2, each developing device 20 includes an accommodation housing 22 that accommodates a two-component developer 21 containing a toner, a magnetic carrier, and an external additive. A first developing roller 23 and a second developing roller 24 functioning as developing members are provided in an area where the accommodation housing 22 opens toward the corresponding photoconductor drum 1. In the accommodation housing 22, a first developer accommodation chamber 25 and a second developer accommodation chamber 26 are provided behind the developing rollers 23 and 24. The developer accommodation chambers 25 and 26 are respectively provided with a first stirrer transport member 27 and a second stirrer transport member 28 that stir and transport the two-component developer 21 and supply the two-component developer 21 to the first developing roller 23. The first developing roller 23 and the second developing roller 24 are surrounded by a layer regulating member 29 that regulates the layer thickness of the two-component developer 21 magnetically attached to the outer peripheral surface of the first developing roller 23, a distributing member 30 that distributes the two-component developer 21 on the first developing roller 23 to the second developing roller 24, an electrode member 31 disposed facing the outer peripheral surface of the second developing roller 24 and to which DC voltage is applied, and a guide member 32 that guides the two-component developer 21 removed from the outer peripheral surface of the second developing roller 24 to an operational area of the first stirrer transport member 27.

The two-component developer (referred to as “developer” hereinafter) 21 contains a resinous toner, a magnetic carrier, and an external additive. When the developer 21 used in this exemplary embodiment is stirred, the magnetic carrier and the external additive are charged to positive polarity, whereas the toner is charged to negative polarity. By magnetically attaching the positively-charged magnetic carrier to the outer peripheral surfaces of the developing rollers 23 and 24, the negatively-charged toner adhered around the magnetic carrier is transported together with the positively-charged external additive adhered to the toner.

The accommodation housing 22 accommodates the developer 21 and supports the two developing rollers 23 and 24, the stirrer transport members 27 and 28, the layer regulating member 29, the distributing member 30, the electrode member 31, and the guide member 32. In an opening of the accommodation housing 22 that faces the photoconductor drum 1, the first developing roller 23 and the second developing roller 24 are disposed facing the photoconductor drum 1 with a certain distance therebetween.

The two stirrer transport members 27 and 28 are arranged along the axes of the developing rollers 23 and 24 and are screw-shaped members having helical blades around the central axes thereof. The stirrer transport members 27 and 28 are arranged in parallel to each other with a partition 33 interposed therebetween. The partition 33 has openings (not shown) at opposite ends thereof in the axial direction. The stirrer transport members 27 and 28 transport the developer 21 in the axial direction and are rotationally driven so as to transport the developer 21 in opposite directions from each other. Thus, the developer 21 is delivered between the two stirring areas via the openings provided in the partition 33 so as to circulate between the first developer accommodation chamber 25 and the second developer accommodation chamber 26 partitioned by the partition 33. Then, the developer 21 is supplied to the first developing roller 23 by the first stirrer transport member 27, whereby the developer 21 becomes magnetically attached to the outer peripheral surface of the first developing roller 23.

The first developing roller 23 and the second developing roller 24 respectively include magnet rollers 23a and 24a fixedly supported by the accommodation housing 22 and substantially-cylindrical sleeves 23b and 24b supported in a rotatable manner along the outer peripheral surfaces of the magnet rollers 23a and 24a.

The magnet rollers 23a and 24a have multiple magnetic poles in the circumferential direction thereof, and are capable of magnetically attaching or removing the developer 21 to or from the outer peripheral surfaces of the sleeves 23b and 24b by utilizing the effect of a magnetic force. Each of these magnetic poles is provided substantially uniformly in the axial direction of the corresponding magnet roller 23a or 24a, such that substantially the same magnetic field is generated in the surrounding area thereof at any position in the axial direction.

The first sleeve 23b included in the first developing roller 23 is rotationally driven in a direction indicated by an arrow C in FIG. 2. Specifically, the first sleeve 23b is rotationally driven such that the peripheral surface thereof moves in the same direction as the photoconductor drum 1 at a position where the peripheral surface faces the photoconductor drum 1 driven in a direction indicated by an arrow B. The second sleeve 24b included in the second developing roller 24 is driven in a direction indicated by an arrow D. Thus, the opposing peripheral surfaces of the first sleeve 23b and the second sleeve 24b move in the same direction at a position where they face each other, that is, the delivery position of the developer 21, whereas the opposing peripheral surfaces of the second sleeve 24b and the photoconductor drum 1 move in opposite directions at a position where they face each other.

As shown in FIG. 2, for example, in the following order in the rotational direction of the first sleeve 23b from a position to which the developer 21 supplied from the stirrer transport member 27 attaches, the magnetic poles provided in the first magnet roller 23a included in the first developing roller 23 include an attachment pole S1 to which the supplied developer 21 attaches, a delivery pole N2 that is magnetized at a position facing the second developing roller 24 and delivers the developer 21 supported by the first sleeve 23b to the second sleeve 24b, a development pole S3 magnetized at a position facing the photoconductor drum 1, a transport pole N4 that transports the developer 21 by attaching it to the outer peripheral surface of the first sleeve 23b, and a removal pole S5 provided adjacent to the attachment pole S1 and having the same polarity as the attachment pole S1.

The second magnet roller 24a included in the second developing roller 24 similarly has five magnetic poles in the circumferential direction thereof. Specifically, in the following order in the rotational direction of the second sleeve 24b from a position facing the first developing roller 23, the five magnetic poles include a reception pole S6 magnetized at a position facing the first developing roller 23 and receiving the developer 21 from the first magnet roller 23a, a development pole N7 that orients the developer 21 toward the photoconductor drum 1 at a position facing the photoconductor drum 1, a transport pole S8 that transports the developer 21 by attaching it to the outer peripheral surface of the second sleeve 24b, and two removal poles N9 and N10 magnetized to the same polarity and spaced apart from each other in the circumferential direction so as to remove the developer 21 therefrom by utilizing repulsive magnetic fields.

The aforementioned magnetic poles S1 to S8 are S-poles, whereas the aforementioned magnetic poles N2 to N10 are N-poles.

An AC superimposed on DC voltage is applied as a development bias voltage to each of the developing rollers 23 and 24. In this exemplary embodiment, a DC voltage of −650 V and an AC voltage of 1000 V (i.e., a peak-to-peak voltage of 2000 V) are applied in a superimposed manner respectively from a DC power source 35 and an AC power source 36 to each of the magnet rollers 23a and 24a (the voltage applied to the first developing roller 23 is not shown in the drawings).

In this exemplary embodiment, the above voltages are applied to the magnet rollers 23a and 24a. Alternatively, the sleeves 23b and 24b may be provided with electrically-conductive layers, and the above voltages may be applied to the electrically-conductive layers.

The layer regulating member 29 is a tabular member disposed such that an edge thereof faces the outer peripheral surface of the first sleeve 23b, and regulates the amount of developer 21 that is moved while being attached to the first sleeve 23b. The layer regulating member 29 is disposed downstream of a position where the developer 21 is supplied to the first developing roller 23 from the first stirrer transport member 27, as viewed in the moving direction of the outer peripheral surface of the first sleeve 23b.

The distributing member 30 protrudes from the downstream side in the rotational direction of the developing rollers 23 and 24 into a gap formed where the first developing roller 23 and the second developing roller 24 face each other, and extends continuously along the axes of the developing rollers 23 and 24. An edge 30a of the distributing member 30 that protrudes into an opposed area 34 between the first developing roller 23 and the second developing roller 24 distributes the developer 21 linked between the first sleeve 23b and the second sleeve 24b toward the first developing roller 23 and the second developing roller 24.

Although the developer 21 transported to the opposed area 34 by the first developing roller 23 is distributed to the first developing roller 23 and the second developing roller 24 in this exemplary embodiment, the distribution ratio may be changed where necessary.

The guide member 32 is a tabular member whose edge 32a is disposed facing the outer peripheral surface of the second sleeve 24b in an area where the repulsive magnetic fields generated by the two removal poles N9 and N10 provided in the second magnet roller 24a are effective. The guide member 32 guides the developer 21 removed from the second sleeve 24b along the planar surface thereof and introduces the developer 21 to an area within the accommodation housing 22 where the developer 21 is stirred by the first stirrer transport member 27.

The electrode member 31 is a roller member composed of an electrically-conductive material and is rotatably supported about an axis thereof. The electrode member 31 extends in the axial direction of the second sleeve 24b at a position downstream of the development pole N7 and upstream of the reception pole S6 in the rotational direction of the second sleeve 24b, and faces the second sleeve 24b with a certain distance therebetween.

In this exemplary embodiment, the electrode member 31 is disposed so as to face the transport pole S8 provided downstream of the development pole N7 and upstream of a position where the guide member 32 is disposed.

The distance between the second sleeve 24b and the electrode member 31 may range between 200 μm and 2000 μm, so that the distance may be substantially equal to the distance between the second sleeve 24b and the photoconductor drum 1 at a position where they face each other, that is, the development position.

A DC power source 37 applies voltage to the electrode member 31, and the electric potential is set between, for example, −100 V and −800V. The electric potential set for the electrode member 31 may be changeable by using a variable resistor, a switch, or the like. In this exemplary embodiment, a switch 38 is used to switch between −300 V and −800 V so as to apply the voltage to the electrode member 31. By changing the electric potential of the electrode member 31, an electric field acting in a different direction with a different intensity is generated between the electrode member 31 and the second developing roller 24.

The following description relates to how the toner, the magnetic carrier, and the external additive supplied onto the first sleeve 23b and the second sleeve 24b behave in each of the developing devices 20 having the above-described configuration.

The developer 21 stirred by the stirrer transport members 27 and 28 becomes attached onto the first sleeve 23b due to the effect of the attachment pole S1 of the first magnet roller 23a, and is transported as the first sleeve 23b rotates in the direction of the arrow C shown in FIG. 2. The layer regulating member 29 is disposed downstream of the attachment pole S1 and regulates the layer thickness of the developer 21 supported on the first sleeve 23b. Specifically, the amount of developer 21 transported on the first sleeve 23b is adjusted.

The developer 21, whose layer thickness has been regulated, on the first sleeve 23b reaches the opposed area 34 where the first sleeve 23b and the second sleeve 24b face each other as the first sleeve 23b rotates. In the opposed area 34, the delivery pole N2 of the first magnet roller 23a and the reception pole S6 of the second magnet roller 24a face each other, such that the magnetic carrier is linked between these magnetic poles having different polarities, whereby the developer 21 is supported and bridged between the two poles.

The distributing member 30 is disposed in the opposed area 34. The edge 30a of the distributing member 30 abuts on the developer 21 with the magnetic carrier linked between the first sleeve 23b and the second sleeve 24b so as to distribute the developer 21 toward the first sleeve 23b and the second sleeve 24b.

The developer 21 delivered to the second sleeve 24b from the first sleeve 23b in this manner is transported as the second sleeve 24b rotates, thereby reaching a position facing the photoconductor drum 1.

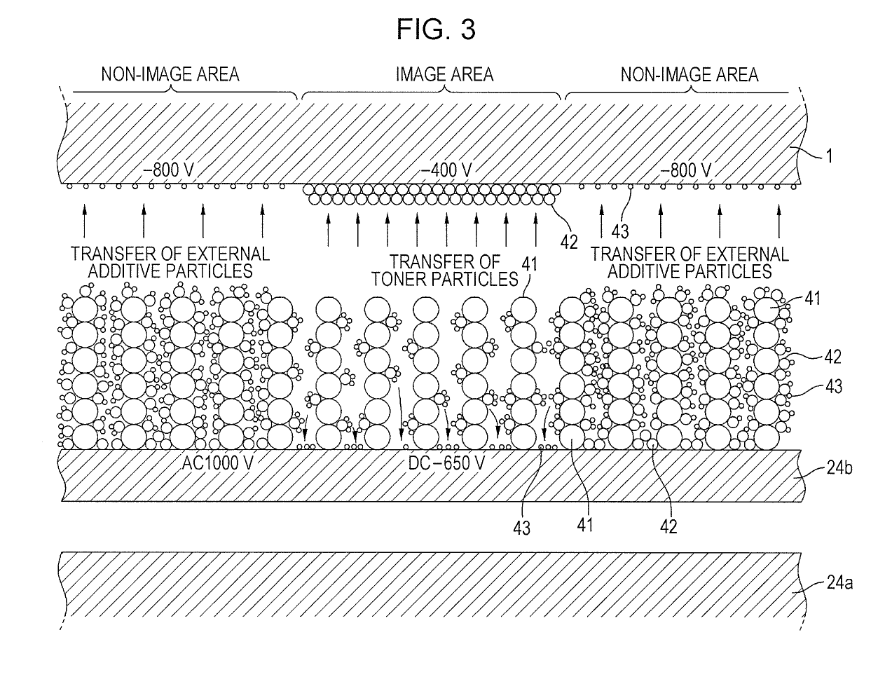

In a development region facing the photoconductor drum 1, the magnetic field of the development pole N7 magnetized by the second magnet roller 24a causes magnetic carrier particles 41 to form chains, as shown in FIG. 3, and the development bias voltage applied between the photoconductor drum 1 and the second magnet roller 24a causes toner particles 42 adhered to the chained magnetic carrier particles 41 on the second sleeve 24b to transfer to the image area, that is, a latent image, on the photoconductor drum 1. Specifically, an electric field generated between the image area (i.e., an area to which the toner particles 42 are to be adhered) in which the electric potential is attenuated to −400 V due to the photoconductor drum 1 being exposed to light and the second sleeve 24b receiving the AC voltage superimposed on the DC voltage of −650 V causes the negatively-charged toner particles 42 to transfer to the latent image on the photoconductor drum 1. Therefore, the toner concentration in the developer 21 on the second sleeve 24b facing this image area decreases. In this case, the magnetic carrier particles 41 are constrained by the magnetic field of the second magnet roller 24a so as to be retained on the second sleeve 24b. Furthermore, the external additive particles 43 are positively charged so as to be pulled toward the second sleeve 24b, and some of them adhere to the surface of the second sleeve 24b.

On the other hand, the non-image area on the photoconductor drum 1 is not exposed to the light so that the electric potential thereof is maintained at −800 V, whereby an electric field in the opposite direction from that in the image area is generated between the non-image area and the second sleeve 24b. Therefore, the negatively-charged toner particles 42 are pulled toward the second sleeve 24b, and some of the toner particles 42 adhered to the magnetic carrier particles 41 become detached from the magnetic carrier particles 41 so as to adhere to the surface of the second sleeve 24b. Furthermore, the positively-charged external additive particles 43 and magnetic carrier particles 41 receive a pulling force toward the photoconductor drum 1, so that some of the external additive particles 43 transfer to the photoconductor drum 1. On the other hand, the magnetic carrier particles 41 are constrained by the magnetic field of the second magnet roller 24a so as to be retained on the second sleeve 24b.

Accordingly, with regard to the developer 21 on the second sleeve 24b, the amount of toner decreases in the area that faces the image area at the development region. In the area that faces the non-image area, the amount of external additive decreases, and the number of toner particles 42 directly adhered to the second sleeve 24b increases. In this state, the developer 21 on the second sleeve 24b moves to the position facing the electrode member 31. Since DC voltage is applied to the electrode member 31, an electric field is generated between the electrode member 31 and the second sleeve 24b.

The DC voltage applied to the electrode member 31 is changeable by switching. For example, when the electrode member 31 receives −300 V, the electric field generated between the electrode member 31 and the second sleeve 24b receiving the AC voltage superimposed on the DC voltage of −650 V acts in the same direction as that when the second sleeve 24b faces the image area on the photoconductor drum 1 at the development region, so that the toner particles 42 supported on the second sleeve 24b are pulled toward the electrode member 31. Specifically, some of the toner particles 42 supported by the magnetic carrier particles 41 on the second sleeve 24b fly toward the electrode member 31 so as to adhere to the surface of the electrode member 31. At the same time, some of the toner particles 42 adhered to the surface of the second sleeve 24b move away from the surface of the second sleeve 24b so as to transfer to the electrode member 31, whereas some of the toner particles 42 are supported by the magnetic carrier particles 41. The external additive particles 43 receive a force that pulls them toward the surface of the second sleeve 24b. Thus, in the area that faces the non-image area on the photoconductor drum 1 at the development region and where a large number of toner particles 42 are adhered to the surface of the second sleeve 24b, the number of toner particles 42 directly adhered to the surface of the second sleeve 24b decreases, whereas the number of external additive particles 43 adhered to the surface of the second sleeve 24b increases. On the other hand, in the area that faces the image area on the photoconductor drum 1 at the development region and where a large number of toner particles 42 are not adhered to the surface of the second sleeve 24b, the toner particles 42 adhered to and remaining on the surface of the second sleeve 24b or the magnetic carrier particles 41 transfer to the electrode member 31, so that the toner particles 42 adhered on the second sleeve 24b are maintained at a small amount. Consequently, a difference in the amount of toner and external additive adhered to the surface of the second sleeve 24b between the areas on the surface of the second sleeve 24b that face the image area and the non-image area on the photoconductor drum 1 may be reduced.

On the other hand, when the electrode member 31 receives a DC voltage of −800 V, the electric field generated between the electrode member 31 and the second sleeve 24b receiving the AC voltage superimposed on the DC voltage of −650 V acts similarly to the area facing the non-image area at the development region, so that the toner particles 42 supported on the second sleeve 24b are pulled toward the second sleeve 24b. The external additive particles 43 receive a force that pulls them away from the second sleeve 24b. Specifically, in the area that faces the image area on the photoconductor drum 1 at the development region and where a large number of toner particles 42 are not adhered to the surface of the second sleeve 24b, some of the toner particles 42 supported by the magnetic carrier particles 41 above the second sleeve 24b are pulled toward the surface of the second sleeve 24b, so that the number of toner particles 42 directly adhered to the surface of the second sleeve 24b increases. Moreover, in the area that faces the non-image area on the photoconductor drum 1 at the development region and where a large number of toner particles 42 are adhered to the surface of the second sleeve 24b, the number of toner particles 42 directly adhered to the surface of the second sleeve 24b also increases. However, since the toner particles 42 near the surface of the second sleeve 24b are already adhered to the surface of the second sleeve 24b, an increase in the number of toner particles 42 adhered to the surface of the second sleeve 24b is smaller than that in the area that faces the image area on the photoconductor drum 1 at the development region. Therefore, a difference in the number of toner particles 42 adhered to the surface of the second sleeve 24b between the area facing the non-image area and the area facing the image area on the photoconductor drum 1 at the development region may be reduced. Furthermore, in the area facing the image area on the photoconductor drum 1 at the development region, the number of external additive particles 43 adhered to the surface of the second sleeve 24b decreases, so that a difference in the number of external additive particles 43 adhered to the surface of the second sleeve 24b between the area facing the non-image area and the area facing the image area on the photoconductor drum 1 at the development region is similarly reduced.

Subsequently, the second sleeve 24b reaches the position where the removal pole N9 is provided. The removal pole N10 having the same polarity as the removal pole N9 is provided downstream thereof such that repulsive magnetic fields are generated therebetween. Thus, the magnetic carrier particles 41 are released and removed from the second sleeve 24b together with the toner particles 42 and the external additive particles 43 adhered to the magnetic carrier particles 41. The guide member 32 is disposed such that the edge 32a thereof protrudes to this position. Thus, the removed developer 21, that is, the magnetic carrier particles 41 having the toner particles 42 and the external additive particles 43 adhered thereto, moves along the guide member 32 so as to be returned to the area where the first stirrer transport member 27 is driven. Then, the surface of the second sleeve 24b from which the magnetic carrier particles 41, having the toner particles 42 and the external additive particles 43 adhered thereto, are removed moves again to the opposed area 34 between the second sleeve 24b and the first sleeve 23b. In the opposed area 34, the developer 21 on the first sleeve 23b is distributed so as to be used for forming a toner image at the development region where each sleeve faces the photoconductor drum 1.

Although the magnetic carrier particles 41 having the toner particles 42 and the external additive particles 43 adhered thereto are removed at the position facing the guide member 32, as described above, many of the toner particles 42 and the external additive particles 43 directly adhered to the surface of the second sleeve 24b remain on the second sleeve 24b. With regard to the residual toner particles 42 and external additive particles 43, the differences in the amounts thereof adhered to the surface of the second sleeve 24b between the area facing the non-image area and the area facing the image area on the photoconductor drum 1 when previously passing through the development region are reduced, so that unevenness in density of an image to be developed when subsequently passing through the development region may be reduced.

If the aforementioned electrode member 31 is not provided, the toner particles 42 and the external additive particles 43 unevenly adhered to the surface of the second sleeve 24b by passing through the development region would be transported to the position provided with the removal pole N9. When the magnetic carrier particles 41 are subsequently removed due to the repulsive magnetic fields, the toner particles 42 and the external additive particles 43 directly adhered to the surface of the second sleeve 24b would remain thereon without being removed therefrom. With regard to the distribution of residual toner particles 42 and external additive particles 43, the unevenness occurring based on the image on the photoconductor drum 1 facing the second sleeve 24b at the development region may possibly be maintained. If the developer 21 is supplied again to the opposed position between the first sleeve 23b and the second sleeve 24b and is transported to the development region while such unevenness remains, unevenness in density based on the opposing image in the previous rotation may occur in a subsequent image to be developed.

In contrast, in the developing device 20 described above, unevenness in the amount of toner and external additive directly adhered to the surface of the second sleeve 24b may be reduced at the position facing the electrode member 31 having received the DC voltage of −300 V or −800 V, thereby reducing unevenness in density of a subsequent image to be developed.

With regard to the first sleeve 23b after delivering a portion of the developer 21 to the second sleeve 24b at the opposed area 34 between the first sleeve 23b and the second sleeve 24b, the outer peripheral surface thereof rotates so as to transport the developer 21 to the position facing the photoconductor drum 1. Then, the first sleeve 23b transfers the toner to the latent image on the photoconductor drum 1, so that the latent image is developed. The first sleeve 23b supporting the developer 21 containing the residual toner and external additive after the developing process continues to rotate so that the developer 21 remaining on the first sleeve 23b is removed therefrom at the removal pole S5. The removed developer 21 is returned to the operational area of the first stirrer transport member 27 where the developer 21 and the other developer therein are stirred together. Subsequently, the developer 21 is supplied again onto the first sleeve 23b at the position where the attachment pole S1 is provided.

When the developer 21 supported on the first sleeve 23b passes through the development region where the photoconductor drum 1 and the first sleeve 23b face each other, the toner particles transfer to the image area, and the toner particles and the external additive particles adhere to the surface of the first sleeve 23b, similarly to when the developer 21 passes through the region where the photoconductor drum 1 and the second sleeve 24b face each other. However, a portion of the developer 21 attached to the first sleeve 23b is retained at the upstream side of the position facing the layer regulating member 29 and is rubbed against the outer peripheral surface of the first sleeve 23b, as well as being stirred. Therefore, unevenness in toner particles and external additive particles occurring when passing through the development region may be eliminated, thereby reducing the occurrence of the image history appearing in the subsequent image.

The aforementioned DC voltage applied to the electrode member 31 may be changed by switching the switch 38, and this switching operation may be performed on the basis of predetermined conditions. For example, after the latent image formed on the photoconductor drum 1 passes through a region that faces the second developing roller 24, that is, the development region, the switching may be performed before a subsequent latent image reaches the development region. When developing the latent image on the photoconductor drum 1 by transferring toner thereto, a voltage of −300 V is applied to the electrode member 31, and the voltage is switched to −800 V after this latent image has passed the development region. Then, the voltage is switched back to −300 V before the subsequent latent image arrives. In other words, the voltage of −300 V is used for image formation, whereas the voltage of −800 V is used when not forming an image.

By periodically switching the voltage to be applied to the electrode member 31 in the order: −300 V, −800 V, −300 V, and −800 V, the direction of the electric field generated between the electrode member 31 and the second sleeve 24b is repeatedly inverted so that the toner-pulling direction is changed. Thus, a continuous increase in the amount of toner retained on the surface of the electrode member 31 may be prevented. Furthermore, since the toner particles 42 may be prevented from being retained on the second sleeve 24b or the electrode member 31 over a long period of time, toner fixation may be suppressed.

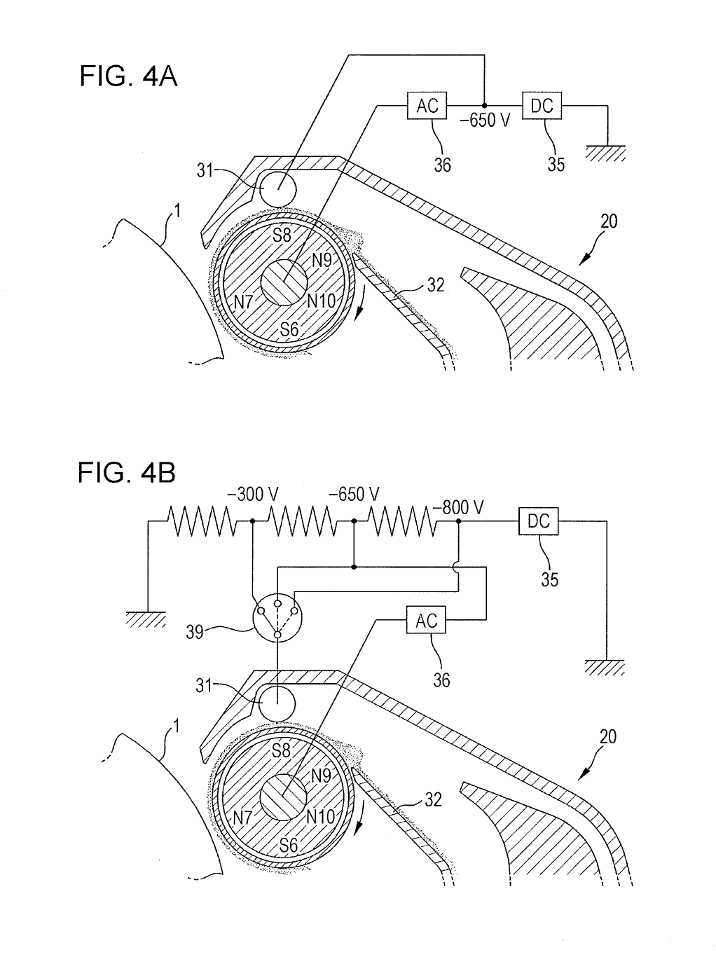

The voltage applied to the electrode member 31 may be the same as the DC component of the voltage applied to the second developing roller 24 as a development bias voltage. Specifically, as shown in FIG. 4A, a DC voltage of −650 V may be applied to the electrode member 31 from the DC power source 35 used for applying the development bias voltage. When the voltage is applied in this manner, the toner particles 42 supported on the second sleeve 24b does not receive a pulling force toward the electrode member 31 or the second sleeve 24b. However, the AC component of the development bias voltage applied to the second developing roller 24, that is, an AC voltage of 1000 V, causes the toner particles 42 to vibrate on the second sleeve 24b toward and away from the surface of the second sleeve 24b. Thus, some of the toner particles 42 adhered to the surface of the second sleeve 24b adhere to the magnetic carrier particles 41. Consequently, the toner particles 42 are removed from the second sleeve 24b together with the magnetic carrier particles 41 at the position where the removal pole N9 is provided, whereby the amount of toner directly adhered to the surface of the second sleeve 24b decreases. Therefore, unevenness in the amount of toner remaining on the second sleeve 24b after the magnetic carrier particles 41 are removed therefrom may be reduced, whereby unevenness in density of a subsequent image to be developed may be reduced.

When a voltage that is the same as the DC component of the development bias voltage applied to the second developing roller 24 is applied to the electrode member 31 in this manner, the toner may be prevented from being retained on the electrode member 31 or fixed on the electrode member 31 and the second sleeve 24b.

Furthermore, referring to FIG. 4B, the voltage that is the same as the DC component of the development bias voltage may be switched to a voltage lower than the aforementioned voltage or a voltage higher than the aforementioned voltage by using a switch 39 before being applied to the electrode member 31.

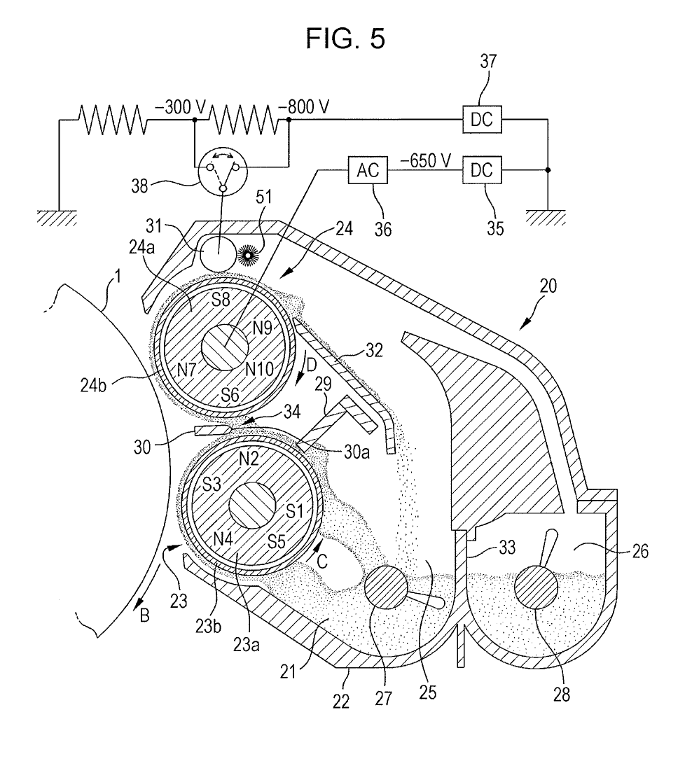

Referring to FIG. 5, a cleaning member, such as a cleaning brush 51, may be disposed in contact with the peripheral surface of the electrode member 31. With such a cleaning member, the toner or the external additive adhered to the surface of the electrode member 31 can be scraped off so as to be returned to the developer layer formed on the second sleeve 24b. Therefore, the toner and the external additive may be prevented from being retained on the electrode member 31.

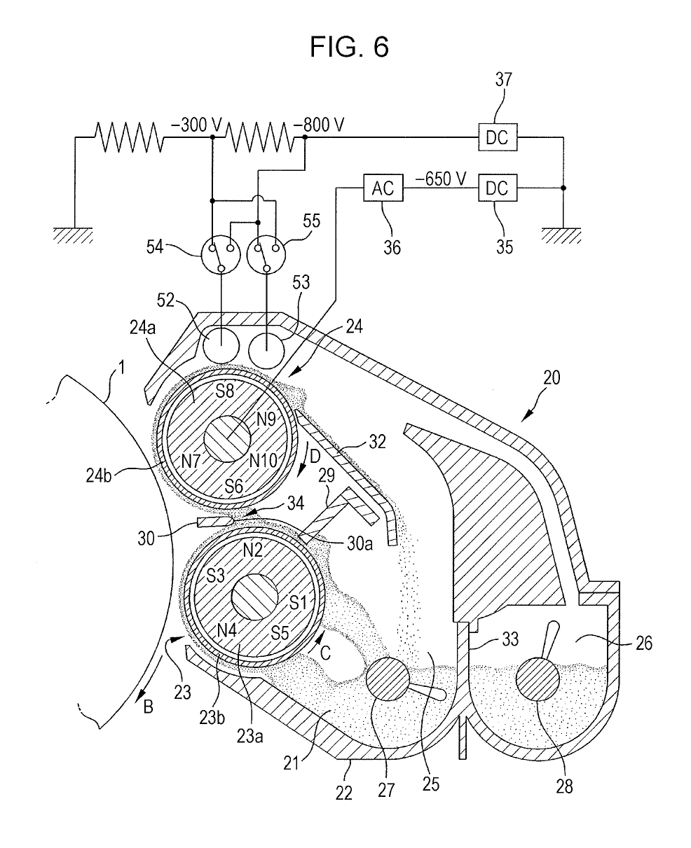

As an alternative to the above exemplary embodiment in which a single electrode member 31 is provided, multiple electrode members 52 and 53 that receive different DC voltages may be provided, as shown in FIG. 6. For example, when a voltage of −300 V is applied to the first electrode member 52 disposed at the upstream side in the rotational direction of the second sleeve 24b and a voltage of −800 V is applied to the second electrode member 53 disposed at the downstream side, the toner on the second sleeve 24b is pulled toward the first electrode member 52, and the external additive on the second sleeve 24b is pulled toward the second electrode member 53. Thus, unevenness in the toner and the external additive supported on the second sleeve 24b may be reduced.

The voltages applied to the first electrode member 52 and the second electrode member 53 may be switched by using switches 54 and 55 in accordance with predetermined conditions. For example, the voltage for the first electrode member 52 previously receiving −300 V may be switched to −800 V, and the voltage for the second electrode member 53 previously receiving −800 V may be switched to −300 V, thereby inverting the directions of the electric fields. Such switching of the voltages may be performed, for example, every time an image is to be formed on a single sheet.

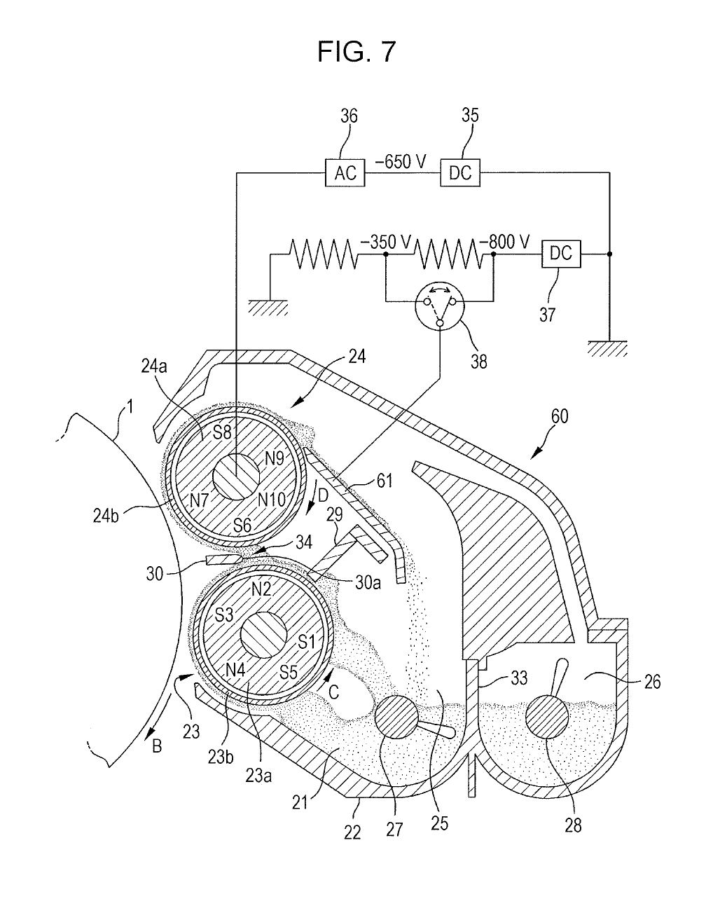

FIG. 7 schematically illustrates a developing device according to a second exemplary embodiment of the present invention.

A developing device 60 uses a guide member 61 in place of the guide member 32 in the first exemplary embodiment. Specifically, the guide member 61 has the same shape as the guide member 32 but has an additional function of an electrode member by receiving DC voltage. Because the configuration of the developing device 60 is similar to the developing device 20 according to the first exemplary embodiment, the following description will be directed to the guide member 61. The remaining components of the developing device 60 will be given the same reference numerals as in the first exemplary embodiment, and descriptions of such components will be omitted.

The guide member 61 in the developing device 60 according to this exemplary embodiment is similar to that in the first exemplary embodiment in that the guide member 61 is disposed in an area where the repulsive magnetic fields generated by the two removal poles N9 and N10 provided in the second magnet roller 24a are effective. The DC power source 37 applies DC voltage to the guide member 61, and the switch 38 is used to switch between −300 V and −800 V so as to apply the voltage to the guide member 61.

When a DC voltage of, for example, −300 V is applied to the guide member 61, the toner directly adhered to the surface of the second sleeve 24b is pulled toward the guide member 61 so as to transfer toward the guide member 61 together with the magnetic carrier removed from the second sleeve 24b due to the repulsive magnetic fields generated by the removal poles N9 and N10. Thus, the amount of toner directly adhered to the surface of the second sleeve 24b decreases, whereby unevenness in the amount of toner adhered to the surface of the second sleeve 24b may be reduced.

On the other hand, when −800 V is applied to the guide member 61, the toner is pulled toward the second sleeve 24b and becomes detached from the magnetic carrier removed therefrom due to the effect of the removal poles N9 and N10, thereby adhering to the surface of the second sleeve 24b. Thus, in the area previously facing the image area on the photoconductor drum 1 at the development region, the amount of toner adhered to the surface of the second sleeve 24b increases. Since the toner is already adhered to the surface of the second sleeve 24b in the area previously facing the non-image area on the photoconductor drum 1 at the development region, the amount of toner that is to be additionally adhered onto the second sleeve 24b is smaller than that in the area facing the image area. Therefore, a difference in the amount of toner adhered to the surface of the second sleeve 24b between the area facing the non-image area and the area facing the image area on the photoconductor drum 1 at the development region may be reduced.

Similar to the first exemplary embodiment, a DC voltage of −650 V may be applied to the guide member 61 functioning as an electrode member.

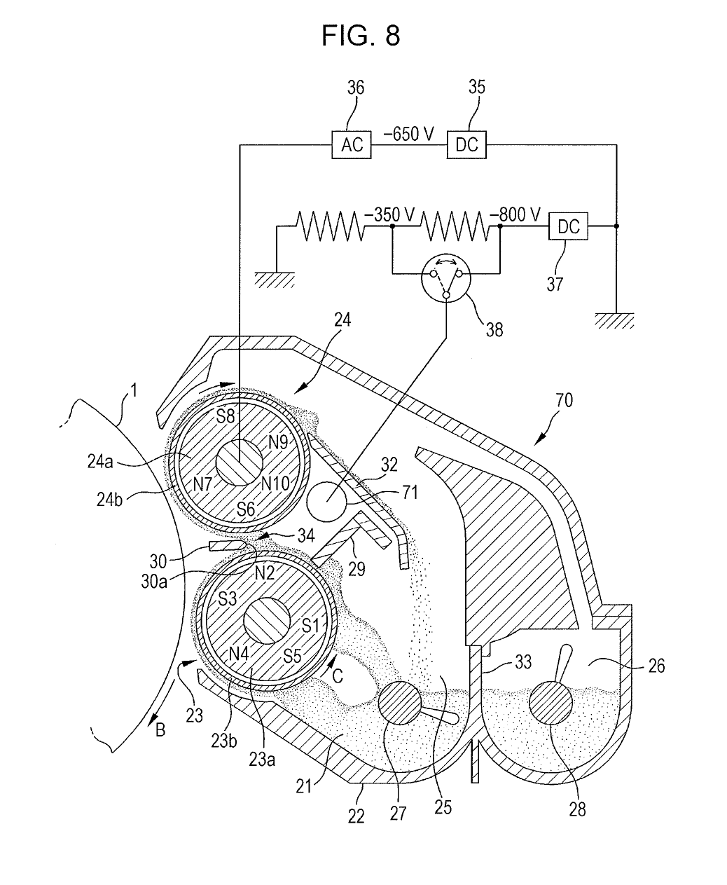

FIG. 8 schematically illustrates a developing device according to a third exemplary embodiment of the present invention.

A developing device 70 differs from that in the first exemplary embodiment in terms of the position of an electrode member 71, but is similar to the first exemplary embodiment in terms of the remaining components excluding the electrode member 71. Therefore, the following description will be directed to the electrode member 71. The remaining components will be given the same reference numerals as in the first exemplary embodiment, and descriptions of such components will be omitted.

In this exemplary embodiment, the electrode member 71 is disposed downstream of the guide member 32 in the rotational direction of the second sleeve 24b and upstream of the reception pole S6 magnetized by the second magnet roller 24a. The shape of the electrode member 71 may be the same as that in the first exemplary embodiment. Furthermore, the DC voltage to be applied is set such that an electric field that causes the toner on the second sleeve 24b to be pulled toward the electrode member 71 or an electric field that causes the toner on the electrode member 71 to be pulled toward the second sleeve 24b is generated. For example, the DC voltage to be applied may be switched between −300 V and −800 V.

In this developing device 70, the distribution of the toner or the external additive adhered to the surface of the second sleeve 24b after passing through the development region is uneven, as shown in FIG. 3. When the developer in this state reaches the position where the removal pole N9 is provided, a large amount of toner and external additive is removed together with the magnetic carrier. However, a large amount of toner directly adhered to the surface of the second sleeve 24b remains thereon in an uneven state without being removed therefrom. As the second sleeve 24b further rotates so as to face the electrode member 71 receiving −300 V in a state where the magnetic carrier is removed from the second sleeve 24b while the toner remains thereon, the toner adhered thereto is pulled toward the electrode member 71 so as to adhere to the electrode member 71. Consequently, the amount of toner adhered on the surface of the second sleeve 24b decreases, whereby unevenness in the amount of toner adhered thereto may be reduced.

With regard to the toner transferred to the electrode member 71, for example, the DC voltage applied to the electrode member 71 is switched to −800 V when the latent image on the photoconductor drum 1 is not being developed, so that the toner can be returned onto the second sleeve 24b. Alternatively, a cleaning member may be provided for scraping off the toner.

The above exemplary embodiments of the present invention are not limited thereto and may be implemented as other exemplary embodiments so long as they are within the scope thereof.

For example, the number and the arrangement pattern of magnetic poles provided in the first magnet roller and the second magnet roller are not limited to those in the above exemplary embodiments. Furthermore, the number of developing rollers is not limited to two, and may be three or more. Moreover, the rotational direction of the developing rollers may be changed.

Furthermore, the development bias voltage applied to each developing roller may be set to various values depending on the characteristics of the developing device. Moreover, the DC voltage or voltages applied to the electrode member or members may be set in correspondence with the aforementioned development bias voltage or voltages. Furthermore, as an alternative to inter-switching the DC voltage between a voltage higher than the DC component of the development bias voltage applied to the second developing roller and a voltage lower than the DC component, the DC voltage may be switched between multiple voltages including substantially the same voltage as the DC component of the development bias voltage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
an accommodation housing that accommodates a two-component developer containing a toner and a magnetic carrier;
a plurality of developing members disposed facing an image bearing member having a latent image formed thereon due to a difference in electrostatic potential, the plurality of developing members including a first developing member and a second developing member, the first developing member having a substantially-cylindrical first sleeve rotationally driven in a circumferential direction thereof and a first magnet roller fixedly supported within the first sleeve and provided with magnetic poles at a plurality of positions in the circumferential direction, the second developing member having a substantially-cylindrical second sleeve rotationally driven in a circumferential direction thereof and a second magnet roller fixedly supported within the second sleeve and provided with magnetic poles at a plurality of positions in the circumferential direction;
a supply member that supplies the two-component developer onto the first sleeve of the first developing member;
a layer regulating member that faces the first sleeve and regulates a layer of the two-component developer supported on a peripheral surface of the first sleeve by the first magnet roller provided within the first sleeve; and
an electrode member facing the second sleeve with a certain distance therebetween and disposed upstream, in a rotational direction of the second sleeve included in the second developing member, of a position where the second sleeve receives the two-component developer from the first sleeve and downstream of a position where the second developing member having received the two-component developer regulated by the layer regulating member faces the image bearing member,
wherein an electric field that causes the toner adhered to a peripheral surface of the second sleeve to be removed therefrom or an electric field that causes the toner adhered to a surface of the magnetic carrier to adhere to the peripheral surface of the second sleeve is generated between the electrode member and the second sleeve.

2. The developing device according to claim 1, wherein an electric potential of the electrode member is interchanged between a voltage higher than a direct-current component of a voltage applied to the second developing member and a voltage lower than the direct-current component on the basis of a predetermined condition.

3. The developing device according to claim 1, wherein the electrode member is a rotatably-supported roller.

4. The developing device according to claim 1, wherein the electrode member is provided in an area where a repulsive magnetic field generated by two poles having the same polarity on the second magnet roller included in the second developing member is effective, and guides the two-component developer removed from the second sleeve due to the repulsive magnetic field to a developer accommodation chamber provided within the accommodation housing.

5. The developing device according to claim 3, wherein the electrode member is provided with a cleaning member.

6. The developing device according to claim 3, further comprising a guide member that is provided in an area where a repulsive magnetic field generated by two poles having the same polarity on the second magnet roller included in the second developing member is effective, and that guides the two-component developer removed from the second sleeve due to the repulsive magnetic field to a developer accommodation chamber provided within the accommodation housing,
wherein the electrode member is provided downstream, in the rotational direction of the second sleeve, of a position where the guide member is disposed.

7. An image forming apparatus comprising:
an image bearing member having an endless peripheral surface on which a latent image is formed due to a difference in electrostatic potential;
the developing device according to claim 1 that forms a toner image by adhering toner to the latent image on the image bearing member;
a transfer device that transfers the formed toner image onto a transfer medium; and
a fixing device that fixes the toner image onto the transfer medium.
